(19) United States
(12) Patent Application Publication
(10) Pub. No.: US 2021/0119377 A1
(43) Pub. Date: Apr. 22, 2021

(54) WATERPROOF FEMALE CONNECTOR

(71) Applicant: Cheng Uei Precision Industry Co., LTD., New Taipei City (TW)

(72) Inventors: LI-NIEN HSU, New Taipei City (TW); SHENG-NAN YU, New Taipei City (TW)

(21) Appl. No.: 16/903,364

(22) Filed: Jun. 16, 2020

(30) Foreign Application Priority Data
Oct. 18, 2019 (CN) 201921752362.0

(51) Int. Cl. H01R 13/52

(52) U.S. Cl. CPC H01R 13/5216; H01R 13/5202

(57) ABSTRACT

A waterproof female connector, comprising a housing having a base section, a tongue section extended from a front end of the base section, and a cavity formed in the base section; a plurality of terminals secured to the first insulator, each of the terminals having a contacting section exposed on a surface of the tongue section, a solder foot exposed outside the housing, and a body portion connected between the contacting section and the foot section, a part of each the body portion exposed from the cavity; a elastomeric filled in the cavity and sealed the part of each the body portion, the waterproof plastic having an annular rib protruded outside the cavity; and a shell enclosed the housing and the elastomeric, and the annular rib being squeezed by an inner surface of the shell.

### CROSS REFERENCE TO RELATED APPLICATION

The present application is based on, and claims priority from, China Patent Application No. 201921752362.0, filed Oct. 18, 2019, the disclosure of which is hereby incorporated by reference herein in its entirety.

### BACKGROUND OF THE INVENTION

### 1. Field of the Invention

The present invention relates to a connector, in particular to a waterproof female connector.

### 2. The Related Art

A conventional Type-C female connector includes an insulator, a upper terminal set, a lower terminal set and a shell, the insulator has a base section and a tongue section, the upper terminal set and the lower terminal set are formed on the insulator and include a plurality of contacting section exposed on the upper and lower sides of the tongue section and a plurality of solder feet exposed on the lower side of the base section, the shell is arranged to enclose the insulator. In order to achieve a better waterproof effect, a dispensing hole will be arranged next to the solder feet of the insulator, and the insulator will be glued and heated after the shell installed on the insulator. However, the waterproof adhesive applied on the insulator may contain air bubbles which are easily to explore in the heating oven. Besides the waterproof adhesive may not flow well and may not cover the insulator fully. Therefore the waterproofing function of the Type-C female connector is not well.

Compared to the conventional female connector, the female connector in this invention forms a elastomeric at the rear end of the first insulator to seal the rear end of the first insulator and wrap the respective parts of the upper terminal set and the lower terminal set which are completely in the elastomerics. Besides, the gap between the first insulator and the shell is sealed by the interfering contact between the elastomeric and the shell. The female connector in this invention replaces the waterproof adhesive with the elastomeric, so no air bubbles flows in while injecting the waterproof adhesive, doesn't be affected by the oven, and no flow problem of the waterproof adhesive. As a result, the present invention provides a better waterproof effect. Furthermore, in the present invention the shell is assembled after the elastomerics is formed. The process is better than the process of assembling the shell before waterproof processing in prior art. That ensures the waterproof performance of the female connector.

Therefore, it is necessary to provide a female connector with better waterproof performance.

### SUMMARY OF THE INVENTION

The objective of the present invention is to provide a plug connector with better waterproof performance.

To achieve said objective, a waterproof female connector, comprising a housing having a base section, a tongue section extended from a front end of the base section, and a cavity formed in the base section; a plurality of terminals secured to the first insulator, each of the terminals having a contacting section exposed on a surface of the tongue section, a solder foot exposed outside the housing, and a body portion connected between the contacting section and the foot section, a part of each the body portion exposed from the cavity; a elastomeric filled in the cavity and sealed the part of each the body portion, the waterproof plastic having an annular rib protruded outside the cavity; and a shell enclosed the housing and the elastomeric, and the annular rib being squeezed by an inner surface of the shell.

In a preferred embodiment, the annular rib is squeezed by the shell to form a sealed contact with the shell when the shell encloses the housing and the elastomeric.

In a preferred embodiment, at least an annular concave groove is formed on the elastomeric to contain a deformation part of the annular rib when the annular rib is squeezed.

In a preferred embodiment, the base section of the housing extends backwardly to form a protrusion section next to the cavity, an end of the elastomeric is surrounded the protrusion section, and the annular rib is surrounded the protrusion section.

In a preferred embodiment, a groove formed on an outer surface of the base section of the housing, the groove has a groove body and a groove entrance, the groove entrance connected between the groove body and the cavity, a limit wall is arranged in the groove body, and the elastomeric has a limit section filled within the groove.

In a preferred embodiment, the housing has a first insulator and a second insulator, the first insulator has the tongue section, the first insulator and the second insulator are divided up the body portion of the housing between themselves, the second insulator is arranged behind the first insulator, the cavity is positioned between the first insulator and the second insulator, contacting sections of the terminals are secured to the first insulator, solder feet of the terminals are secured to the second insulator, the parts of body sections of the terminals are located between the first insulator and the second insulator and sealed in the elastomeric, the shell encloses the second insulator.

In a preferred embodiment, the second insulator has a main section, a bottom surface of the main section is arranged higher than a bottom surface of the first insulator and the elastomeric, the solder feet of the terminals are exposed from the main section, a front end of the main section is protruded downward to form a retaining wall, a lower part of the elastomeric is joined to a front end of the retaining wall.

In a preferred embodiment, the first insulator has a front interior plastic body and a front external plastic body, the front interior plastic body has a central isolation plate formed therein, a plurality of front terminal slots are formed on an upper side and a lower side of the front interior plastic body, the second insulator has a rear interior plastic body and a rear external plastic body enclosed the rear interior plastic body, a plurality of rear terminal slots are formed on an upper side and a lower side of the rear interior plastic body, a connection section inlaid in the rear interior plastic body is formed at a rear end of the central isolation plate, the connection section is connected to a grounding section which is exposed outside of the rear interior plastic body, front ends and rear ends of the body portions of the terminals are arranged in the front terminal slots and the rear terminal slots respectively, the front external plastic body is formed at a front end of the front interior plastic body and the contacting sections of the terminals, the contacting sections of the terminals are exposed on an upper side and a lower side of the front external plastic body, the solder feet of the terminals are exposed outside the rear external plastic body.

In a preferred embodiment, a flange is formed at a front end of the shell, a shell case is enclosed the shell, an annular groove is formed between the flange and a front end of the shell case, and a silicone waterproof ring is arranged in the annular groove.

In a preferred embodiment, a ring-shaped rib is formed on the silicone waterproof ring.

A waterproof female connector, comprising a first insulator having a base section, a tongue section extended from a front end of the base section; a second insulator positioned behind the first insulator; a cavity formed between the first insulator and the second insulator; a plurality of terminals secured to the first insulator and the second insulator, each of the terminals having a contacting section secured to the first insulator and exposed on a surface of the tongue section, a solder foot secured to the second insulator and exposed outside the second insulator, and a body portion secured to first insulator and the second insulator, a part of each the body portion exposed from the cavity; a elastomeric filled in the cavity and sealed the part of each the body portion, the waterproof plastic having an annular rib protruded beyond an outer surface of the base section of the first insulator; and a shell enclosed the first insulator and the elastomeric, the annular rib being squeezed by an inner surface of the shell.

In a preferred embodiment, at least an annular concave groove is formed on the elastomeric to contain a deformation part of the annular rib when the annular rib is squeezed.

A waterproof female connector, comprising a front interior plastic body having a plurality of front terminal slots formed on an top surface and a bottom surface of the front interior plastic body; a rear interior plastic body having a plurality of rear terminal slots formed on an top surface and a bottom surface of the rear interior plastic body; a central isolation plate positioned in the front inter plastic body and the rear plastic body by a first injection molding; a plurality of upper terminals having body portions, front ends of the body portions of the upper terminals positioned in the front terminal slots of the top surface of the front interior plastic body, rear ends of the body portions of the upper terminals positioned in the rear terminal slots of the top surface of the rear interior plastic body; a plurality of lower terminals having body portions, front ends of the body portions of the lower terminals positioned in the front terminal slots of the bottom surface of the front interior plastic body, rear ends of the body portions of the lower terminals positioned in the rear terminal slots of the bottom surface of the rear interior plastic body; a front external plastic body enclosed the front interior plastic body by a second injection molding to form a base section and a tongue section extended from a front surface of the body section, the upper terminals and the lower terminals having contacting sections connected to the front ends of the body portions, the contacting sections of the upper terminals exposed from a top surface of the tongue section, the contacting sections of the lower terminals exposed from a bottom surface of the tongue section; a rear external plastic body enclosed the rear interior plastic body by the second injection molding, the upper terminals and the lower terminals having solder feet connected to the rear ends of the body portions, the solder feet exposed from a bottom surface of the rear external plastic body, the solder feet of the upper terminals arranged in a front row, the solder feet of the lower terminals arranged in a rear row which is behind the front row; a cavity formed between the front external plastic body and the rear external plastic body, the body portions of the upper terminals and the lower terminals having middle sections which are connected between the front ends and the rear ends of the body portions, the middle sections of the body portions of the upper terminals and the lower terminals exposed from the cavity; a elastomeric fully filled the cavity and sealed the middle sections of the body portions of the upper terminals and the lower terminals by a third injection molding, the waterproof plastic having an annular rib protruded beyond an outer surface of the base section of the front external plastic body; and a shell enclosed the front external plastic body and the elastomeric to squeeze the annular rib and deform the annular rib.

### BRIEF DESCRIPTION OF THE DRAWINGS

The present invention will be apparent to those skilled in the art by reading the following description, with reference to the attached drawings, in which:

FIG. 1 is a perspective view of first embodiment of a female connector in this invention;

FIG. 2 is a perspective view of the female connector without a shell case in first embodiment of this invention;

FIG. 3 is a perspective view of the female connector without the shell case and a shell in first embodiment of this invention;

FIG. 4 is an exploded view of the female connector shown in FIG. 3;

FIG. 5 is a perspective view of the female connector without the shell case and shell in second embodiment of this invention;

FIG. 6 is a perspective view of the female connector without the shell case and shell in third embodiment of this invention;

FIG. 7 is a perspective view of the female connector without the shell case and shell in fourth embodiment of this invention;

FIG. 8 is an exploded view of the female connector shown in FIG. 7;

FIG. 9 is a perspective view of the female connector without the shell case and shell in fifth embodiment of this invention;

FIG. 10 is an exploded view of the female connector shown in FIG. 9;

FIG. 11 is a perspective view of the female connector without the shell case and shell in sixth embodiment of this invention;

FIG. 12 is an exploded view of the female connector shown in FIG. 11;

FIG. 13 is a perspective view of the female connector without the shell case and shell in seventh embodiment of this invention;

FIG. 14 is an exploded view of the female connector shown in FIG. 13;

FIG. 15 is a perspective view of a front interior plastic body, a rear interior plastic body, an upper terminal set and a lower terminal set in this invention;

FIG. 16 is a perspective view of a central isolation plate in this invention.

### DETAILED DESCRIPTION OF THE PREFERRED EMBODIMENT

In order to explain in detail, the technical content, structural features, objectives and effects of the present invention, the following is a detailed description with reference to the drawings.

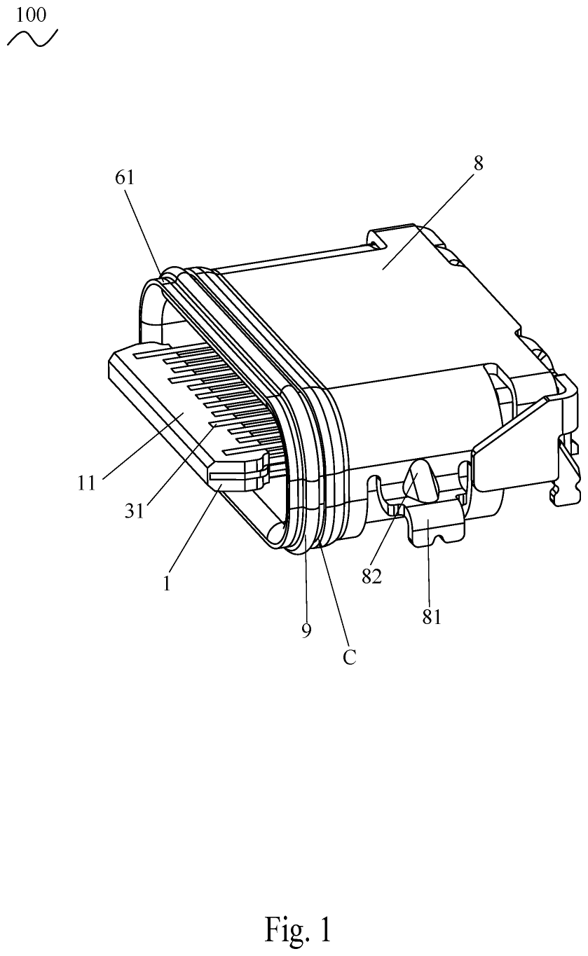

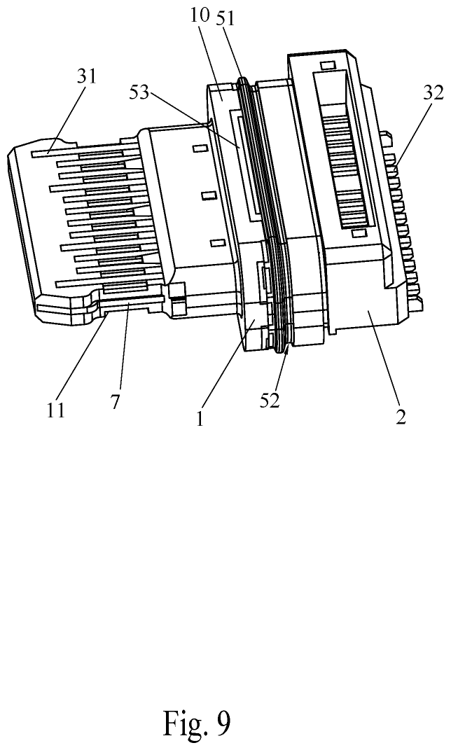

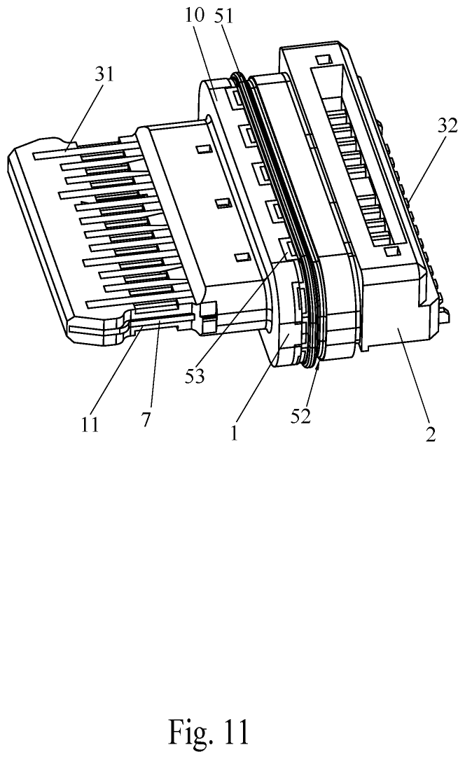

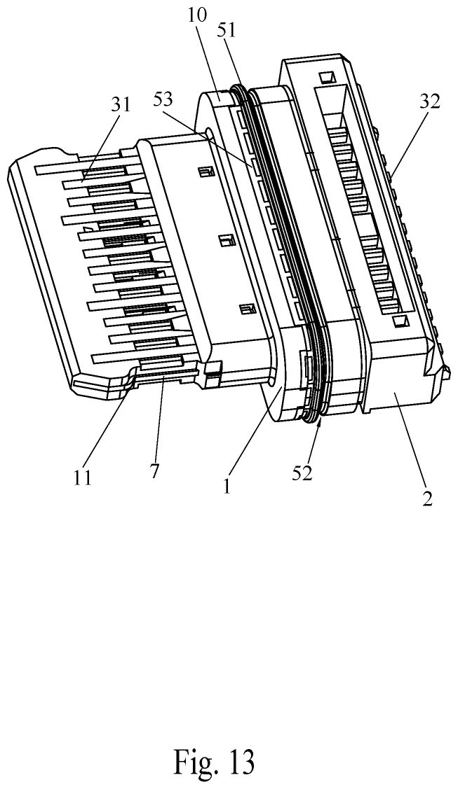

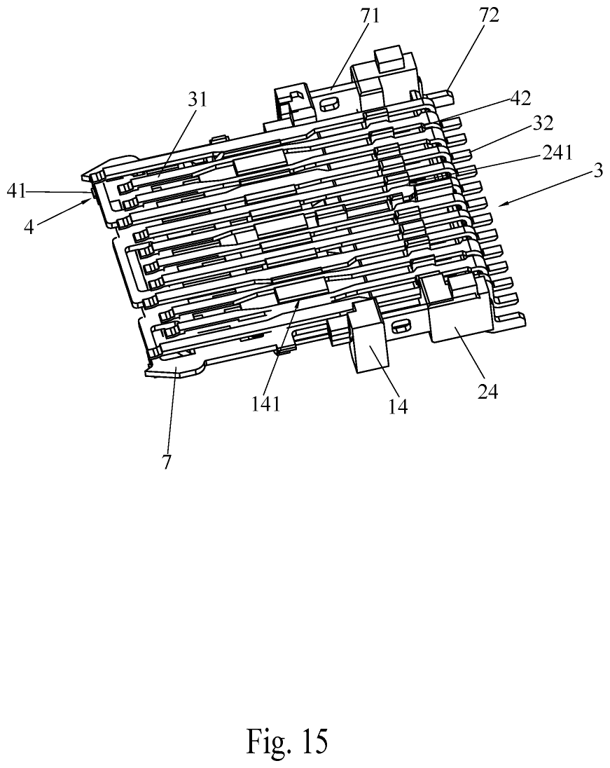

Referring to FIG. 1 to FIG. 15, a female connector 100 has a first insulator 1, an upper terminal set 3, a lower terminal set 4, a elastomeric 5 and a shell 6. The first insulator 1 has a base section 10 and a tongue section 11 extended from a front end of the base section 10. The upper terminal set 3 and the lower terminal set 4 are secured to the first insulator 1, both the upper terminal set 3 and the lower terminal set 4 have a plurality of contacting sections 31, 41 exposed on an up side and a bottom side of the tongue section 11 and a plurality of solder feet 32,42 exposed outside. The elastomeric 5 is injection molded at a rear end of the first insulator 1 to seal corresponding structures of the upper terminal set 3 and the lower terminal set 4 that are located at the rear end of the first insulator 1. The shell 6 encloses the first insulator 1 and the elastomeric 5. The elastomeric 5 is squeezed to form a sealed contact with the shell 6 when the shell 6 encloses the elastomeric 5.

The female connector 100 in this invention forms the elastomeric 5 at the rear end of the first insulator 1 by injection molding to seal the rear end of the first insulator 1 and wrap respective parts of the upper terminal set 3 and the lower terminal set 4 completely in the elastomeric 5. Besides, a gap between the first insulator 1 and the shell 6 is well sealed by an interfering contact between the elastomeric 5 and the shell 6. The female connector 100 in this invention replaces the waterproof adhesive with the elastomeric 5, so no air bubbles flows in while injecting the waterproof adhesive, doesn't be affected by the oven, and no flow problem of the waterproof adhesive. As a result, the present invention provides a better waterproof effect. Furthermore, in the present invention the shell 6 is assembled after the elastomeric 5 is formed. The assembling process is better than a prior assembling process that the shell is assembled before the waterproof adhesive is applied, and ensures the waterproof performance of the female connector 100.

The female connector 100 in the present invention further comprises a second insulator 2, the second insulator 2 is arranged behind the first insulator 1, front ends of the upper terminal set 3 and the lower terminal set 4 are secured to the first insulator 1, rear ends of the upper terminal set 3 and the lower terminal set 4 are secured to the second insulator 2 and extended out to form the solder feet 32, 42. Parts of the upper terminal set 3 and the lower terminal set 4 are located between the first insulator 1 and the second insulator 2, which are sealed in the elastomeric 5. The shell 6 covers a part of the second insulator 2. Because the female connector 100 in the present invention comprises the first insulator 1, the second insulator 2 arranged behind the first insulator 1, and the elastomeric 5 formed between the first insulator 1 and the second insulator 2 by injection molding, that makes the elastomeric 5 more stable and robust, and improves the waterproof ability of the female connector 100 in the present invention. Although the accompanying drawings show only the preferred embodiment containing the second insulator 2, but the female connector 100 of this invention does not exclude technical embodiment that do not include the second insulator 2, and other embodiment having only one insulator shall also be covered by this creation.

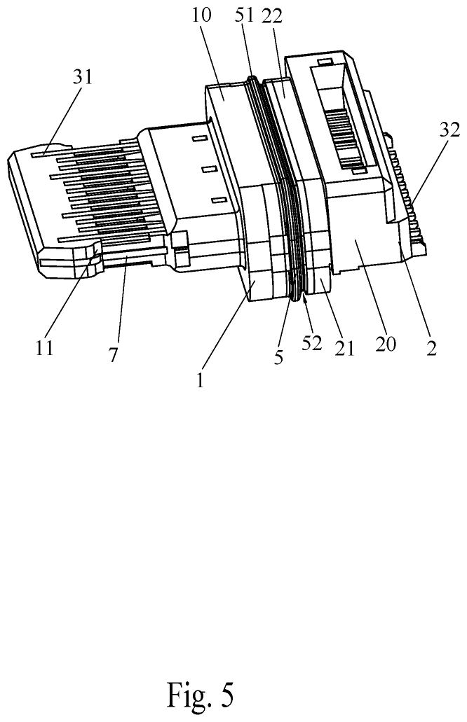

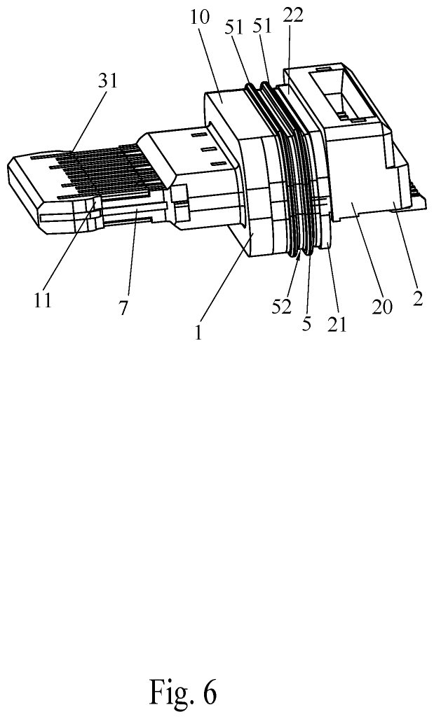

Referring to FIG. 5 and FIG. 6, in a preferred embodiment, the second insulator 2 includes a main section 20, a bottom surface of the main section 20 is arranged higher than a bottom surface of the first insulator 1 and the elastomeric 5. The solder feet 32, 42 of the upper terminal set 3 and the lower terminal set 4 are exposed from the main section 20. A front end of the main section 20 is protruded downward to form a retaining wall 21. A lower part of the elastomeric 5 is joined to a front end of the retaining wall 21. Through the design of the retaining wall 21, the lower part of the elastomeric 5 can be combined with the front end of the retaining wall 21 for enhancing the reliability of the elastomeric 5.

As a preferred embodiment of implementation, the front end of the main section 20 has a convex structure that forms a sleeve part 22 for snapping of the shell 6 with the retaining wall 21. The reliability of the overall structure is further enhanced by the fact that the shell 6 is further snapped onto the sleeve part 22 of the second insulator 2.

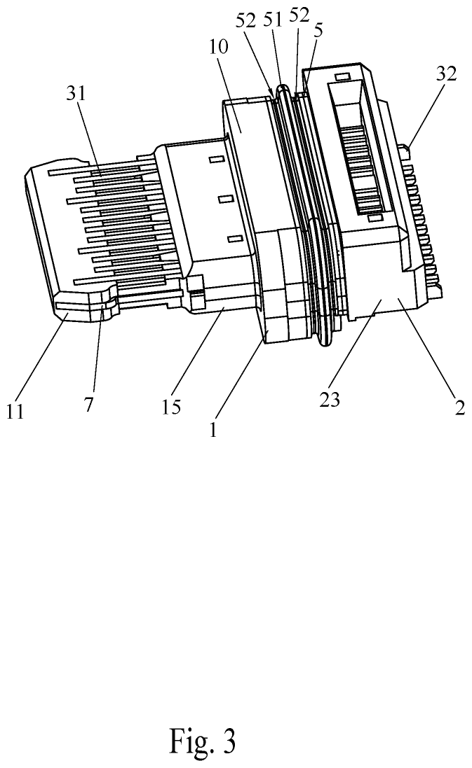

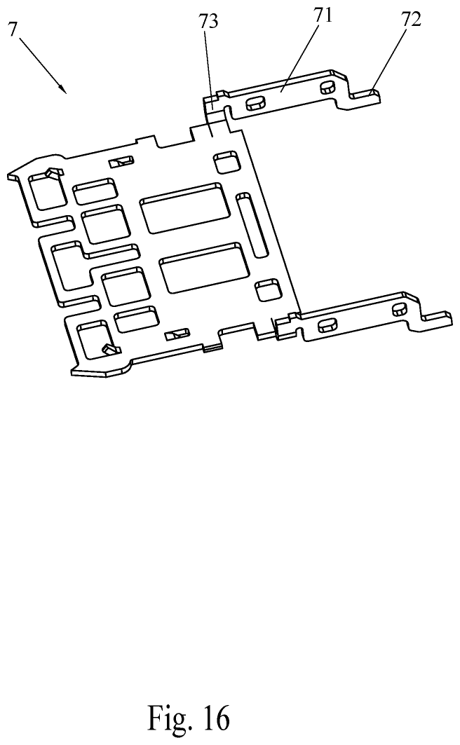

Referring to FIGS. 3, 4, 15 and 16, in this embodiment, the first insulator 1 has a front interior plastic body 14 and a front external plastic body 15, the front interior plastic body 14 includes a central isolation plate 7 formed therein. A plurality of front terminal slots 141 are formed on an upper side and a lower side of the front interior plastic body 14, the second insulator 2 includes a rear interior plastic body 24 and a rear external plastic body 23, a plurality of rear terminal slots 241 are formed on an upper side and a lower side of the rear interior plastic body 24. A connection section 71 inlaid in the rear interior plastic body 24 is formed at a rear end of the central isolation plate 7, the connection section 71 is connected to a grounding section 72 exposed at an outer side of the rear interior plastic body 24. The front ends and the rear ends of the upper terminal set 3 and the lower terminal set 4 are arranged in the front terminal slots 141 and the rear terminal slots 241 respectively. The front external plastic body 15 is formed at a front end of the front interior plastic body 14 and the front ends of the upper terminal set 3 and the lower terminal set 4. The rear external plastic body 23 is formed at a rear end of the rear interior plastic body 24 and the rear ends of the upper terminal set 3 and the lower terminal set 4. The contacting sections 31, 41 of the upper terminal set 3 and the lower terminal set 4 are exposed on an upper side and a lower side of the front external plastic body 15 respectively, the solder feet 32, 42 of the upper terminal set 3 and the lower terminal set 4 are exposed outside the rear external plastic body 23. After the second insulator 2 is formed, a carrier tape (not shown) is removed from the upper terminal set 3 and the lower terminal set 4. By means of the design above, the front interior plastic body 14 and the rear interior plastic body 24 can be steadily connected to one another by means of the central isolation plate 7, so that the upper terminal set 3 and the lower terminal set 4 can be quickly and steadily positioned on the front interior plastic body 14 and the rear interior plastic body 24, thus facilitating the molding of the front external plastic body 15 and the rear external plastic body 23. Besides, the female connector 100 in this invention is produced with two insert molding processes, which reduces the chance of water seepage compared to the conventional female connector with single insert molding process, and has a better waterproofing ability compared to the conventional female connector with assembly method. In addition, the female connector 100 in this invention is able to effectively shorten the production time and reduce production costs compared to the conventional female connector with three insert molding processes which is widely used in the industry.

As a preferred embodiment of implementation, rear ends of two sides of the central isolation plate 7 extend outwardly and bend vertically to form two vertical sections 73, the two vertical sections 73 extend backwardly to form the two connection sections 71, and the two connection sections 71 are connected to the two grounding sections 72 respectively. The design above facilitates a stable connection between the front interior plastic body 14 and the rear interior plastic body 24, and increases the overall stability of the female connector 100 in this invention by soldering the two grounding sections 72 to a circuit board (not shown).

Referring to FIGS. 3 to 14, in this embodiment, the elastomeric 5 includes at least a annular rib 51 extended outwardly from the first insulator 1, and the annular rib 51 is squeezed by the shell 6 to form the sealed contact with the shell 6 when the shell 6 is enclosed. Through the design of the annular rib 51, it achieves the interfering contact between the elastomeric 5 and the shell 6.

As a preferred embodiment, an annular concave groove 52 is formed on the elastomeric 5 to provide a space for containing the annular rib 51 when the annular rib 51 is squeezed. When the shell 6 encloses the first insulator 1 and the elastomeric 5, the annular rib 51 of the elastomeric is extruded to deform. The deformed annular rib 51 is contained in the space of the annular concave groove 52 to improve waterproofing ability.

Referring to FIG. 6, as a preferred embodiment of implementation, the elastomeric 5 has two annular ribs 51 and the annular concave groove 52 is formed between the two annular ribs 51.

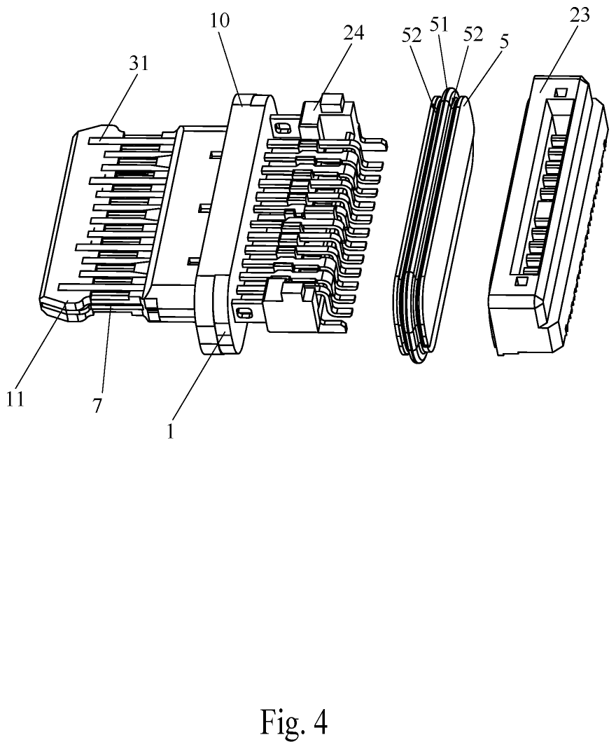

The setting of the annular rib 51 and the annular concave groove 52 should not be limited to a specific way, but any structure that serves the purpose of providing a squeeze space for the annular rib 51. For example, in FIG. 4, the elastomeric 5 has only one annular rib 51, and two the annular concave grooves 52 are arranged on a front side and a rear side of the annular rib 51 respectively for providing the squeeze space for the annular rib 51; in FIG. 5, the elastomeric 5 has only one annular rib 51 and only one annular concave groove 52 located on the rear side of the annular rib 51.

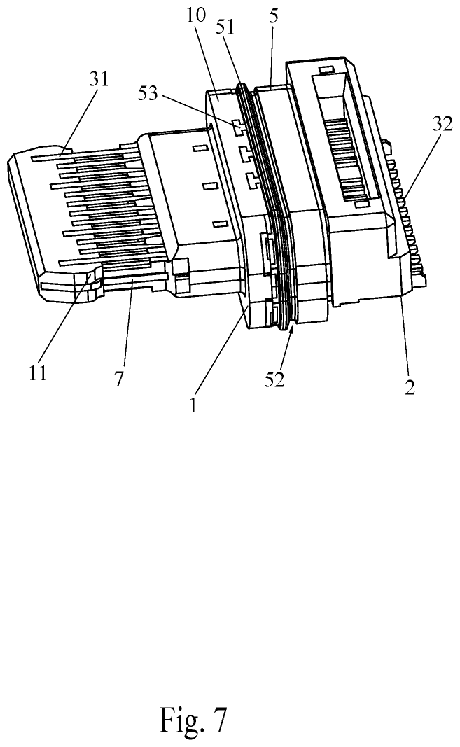

Referring to FIG. 7 to FIG. 14, as a preferred embodiment of implementation, the base section 10 of the first insulator 1 extends backwardly to form a protrusion section 12, a front end of the elastomeric 5 is surrounded on the protrusion section 12, and the annular rib 51 is arranged directly opposite to the protrude section 12. With the design of the annular rib 51 which is arranged directly opposite to the protrude section 12, when the ring-shaped annular rib 51 is squeezed, the protrusion section 12 can supports the internal stress in the elastomeric 5, thus ensuring the stability of the overall structure. The ring-shaped annular rib 51 sleeves on the protrusion section 12.

Referring to FIG. 7 to FIG. 14, in this embodiment, a groove 13 extended backwardly is formed at an outer side of the base section 10 of the first insulator 1, the groove 13 including a groove body 131 and a groove entrance 132 connected at a rear end of the groove body 131, a limit wall 133 formed at the rear end of the groove body 131. The elastomeric 5 filled forward to form a limit section 53 within the groove 13 during a process of forming the elastomeric 5. The design of the groove 13 prevents the elastomeric 5 from overturning and improves the reliability when the elastomeric 5 is squeezed by the shell 6 due to limit the movement of the elastomeric 5 with the limit section 53.

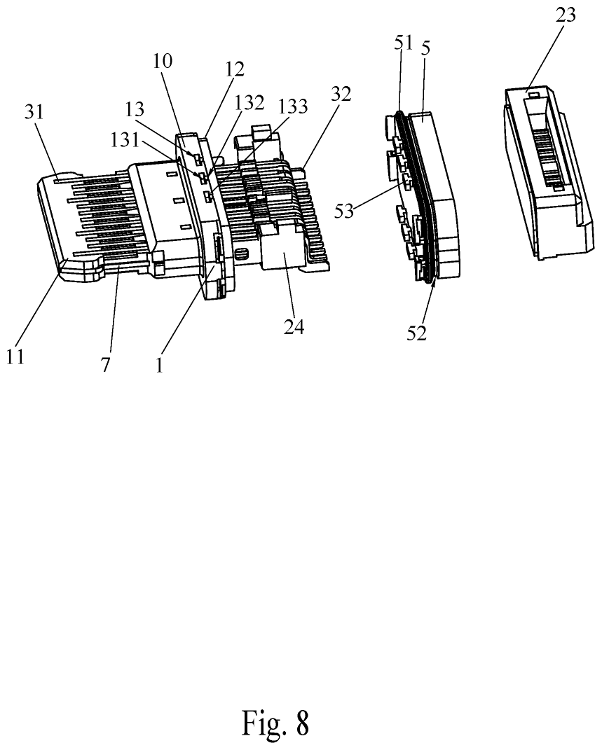

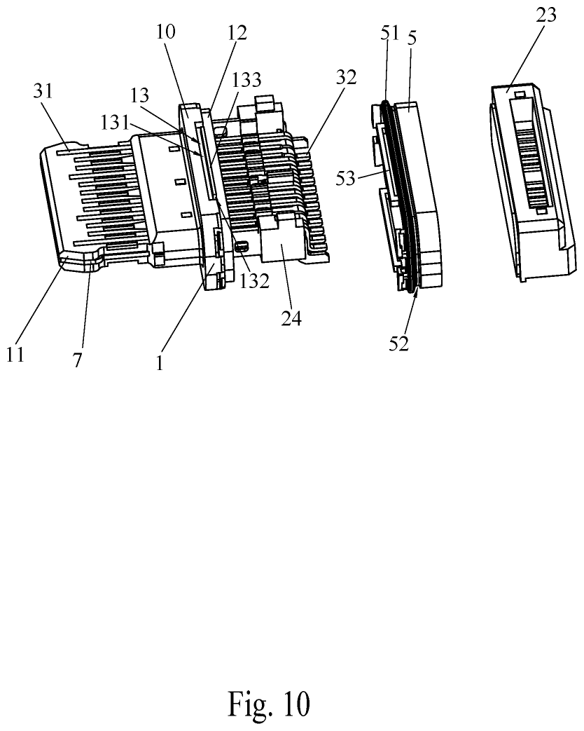

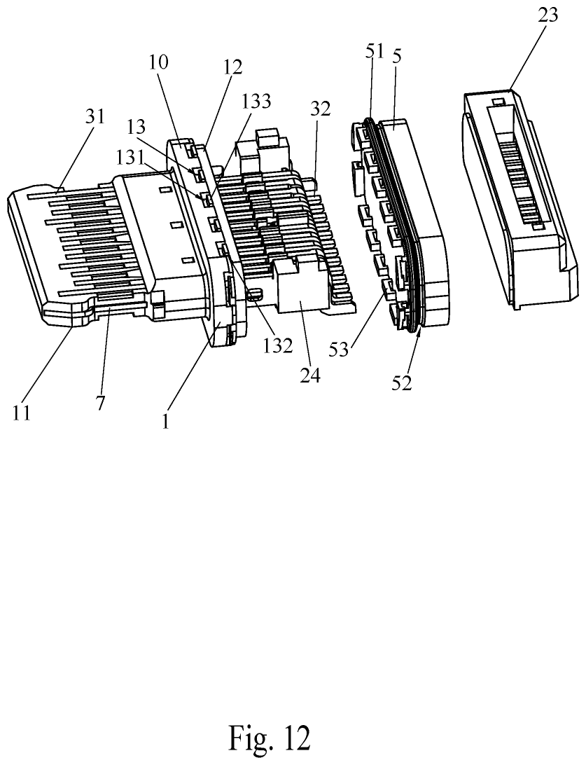

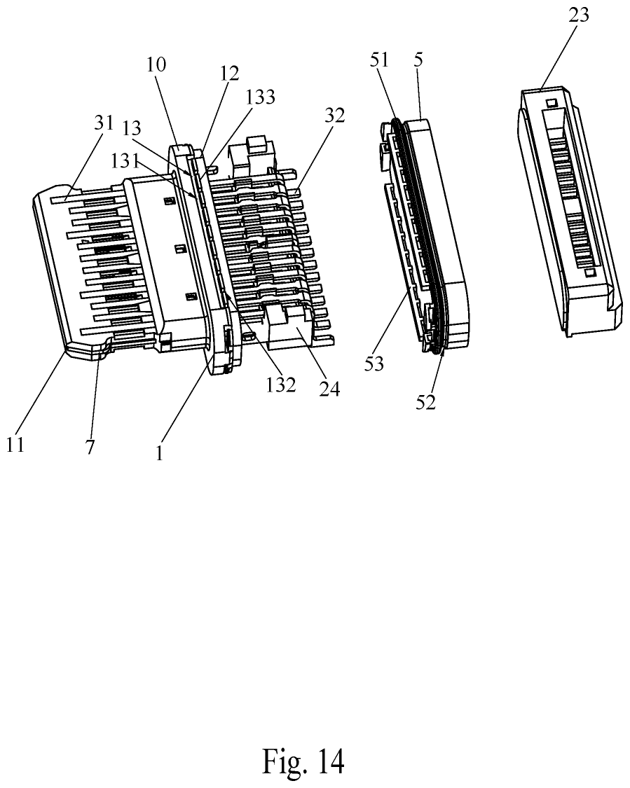

As a preferred embodiment, the groove 13 can be arranged in T shape as shown in the FIG. 8, in U shape as shown in the FIG. 10 and FIG. 12, in grille shape as shown in the FIG. 14, or in various other shapes and should not be limited herein.

As a preferred embodiment, the annular rib 51 arranged next to the groove 13 prevents the elastomerics 5 from overturning.

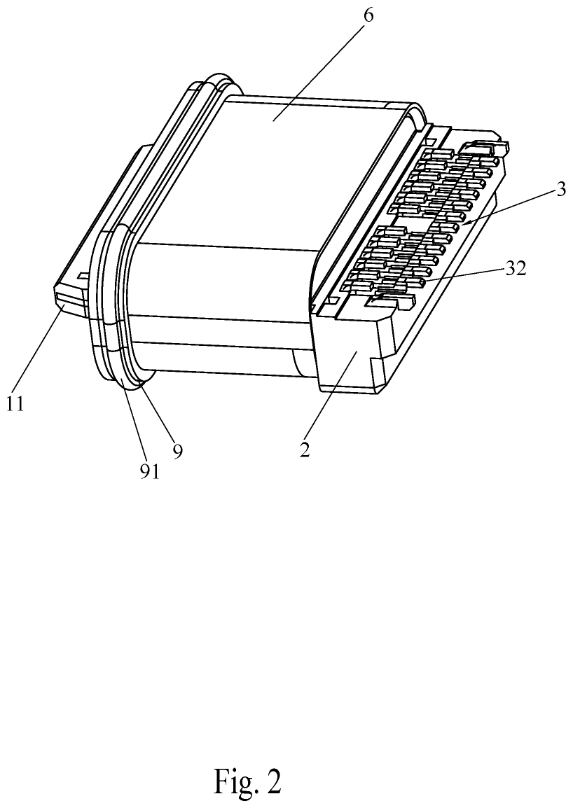

Referring to FIG. 1 and FIG. 2, in a preferred embodiment, a flange 61 is formed at a front end of the shell 6. The female connector 100 in this invention further includes a shell case 8 which is arranged on the shell 6. An annular groove (C) is formed between the shell case 8 and the flange 61 of the shell 6, and a silicone waterproof ring 9 is arranged in the annular groove (C). The silicone waterproof ring 9 formed in the annular groove (C) has the following advantages comparing to a conventional O-ring: more versatile in fitting the case (not shown), less likely to fall off, more reliable and able to pass through the reflow oven when assembled process, thus ensuring a good waterproof seal between the female connector 100 and the case. In a specific embodiment, the shell case 8 is further enclosed over the second insulator 2.

As a preferred embodiment of implementation, a ring-shaped rib 91 formed on the silicone waterproof ring 9 is facilitate interference contact with the inner wall of the housing.

Referring to FIG. 1, in this embodiment, two inverted L-shaped pins 81 are formed at two lateral sides of the shell case 8, and an enhancing ribs 82 is formed at the joint of the pins 81 and a side wall of the shell case 8 to enhance the bending strength.

The above disclosure is only a better example of the present creation, but of course it cannot be used to limit the scope of the rights of the present creation, so the equivalent changes in the scope of the patent application under the present creation are still within the scope of the present creation.

What is claimed is:

1. A waterproof female connector, comprising:
a housing having a base section, a tongue section extended from a front end of the base section, and a cavity formed in the base section;
a plurality of terminals secured to the first insulator, each of the terminals having a contacting section exposed on a surface of the tongue section, a solder foot exposed outside the housing, and a body portion connected between the contacting section and the foot section, a part of each the body portion exposed from the cavity;
an elastomeric filled in the cavity and sealed the part of each the body portion, the waterproof plastic having an annular rib protruded outside the cavity; and
a shell enclosed the housing and the elastomeric, and the annular rib being squeezed by an inner surface of the shell.

2. The waterproof female connector as claimed in claim 1, wherein the annular rib is squeezed by the shell to form a sealed contact with the shell when the shell encloses the housing and the elastomeric.

3. The waterproof female connector as claimed in claim 2, wherein at least an annular concave groove is formed on the elastomeric to contain a deformation part of the annular rib when the annular rib is squeezed.

4. The waterproof female connector as claimed in claim 1, wherein the base section of the housing extends backwardly to form a protrusion section next to the cavity, an end of the elastomeric is surrounded the protrusion section, and the annular rib is surrounded the protrusion section.

5. The waterproof female connector as claimed in claim 1, wherein a groove formed on an outer surface of the base section of the housing, the groove has a groove body and a groove entrance, the groove entrance connected between the groove body and the cavity, a limit wall is arranged in the groove body, and the elastomeric has a limit section filled within the groove.

6. The waterproof female connector as claimed in claim 1, wherein the housing has a first insulator and a second insulator, the first insulator has the tongue section, the first insulator and the second insulator are divided up the body portion of the housing between themselves, the second insulator is arranged behind the first insulator, the cavity is positioned between the first insulator and the second insulator, contacting sections of the terminals are secured to the first insulator, solder feet of the terminals are secured to the second insulator, the parts of body sections of the terminals are located between the first insulator and the second insulator and sealed in the elastomeric, the shell encloses the second insulator.

7. The waterproof female connector as claimed in claim 6, wherein the second insulator has a main section, a bottom surface of the main section is arranged higher than a bottom surface of the first insulator and the elastomeric, the solder feet of the terminals are exposed from the main section, a front end of the main section is protruded downward to form a retaining wall, a lower part of the elastomeric is joined to a front end of the retaining wall.

8. The waterproof female connector as claimed in claim 6, wherein the first insulator has a front interior plastic body and a front external plastic body, the front interior plastic body has a central isolation plate formed therein, a plurality of front terminal slots are formed on an upper side and a lower side of the front interior plastic body, the second insulator has a rear interior plastic body and a rear external plastic body enclosed the rear interior plastic body, a plurality of rear terminal slots are formed on an upper side and a lower side of the rear interior plastic body, a connection section inlaid in the rear interior plastic body is formed at a rear end of the central isolation plate, the connection section is connected to a grounding section which is exposed outside of the rear interior plastic body, front ends and rear ends of the body portions of the terminals are arranged in the front terminal slots and the rear terminal slots respectively, the front external plastic body is formed at a front end of the front interior plastic body and the contacting sections of the terminals, the contacting sections of the terminals are exposed on an upper side and a lower side of the front external plastic body, the solder feet of the terminals are exposed outside the rear external plastic body.

9. The waterproof female connector as claimed in claim 1, wherein a flange is formed at a front end of the shell, a shell case is enclosed the shell, a annular groove is formed between the flange and a front end of the shell case, and a silicone waterproof ring is arranged in the annular groove.

10. The waterproof female connector as claimed in claim 9, wherein a ring-shaped rib is formed on the silicone waterproof ring.

11. A waterproof connector, comprising:
a first insulator having a base section, a tongue section extended from a front end of the base section;
a second insulator positioned behind the first insulator;
a cavity formed between the first insulator and the second insulator;
a plurality of terminals secured to the first insulator and the second insulator, each of the terminals having a contacting section secured to the first insulator and exposed on a surface of the tongue section, a solder foot secured to the second insulator and exposed outside the second insulator, and a body portion secured to first insulator and the second insulator, a part of each the body portion exposed from the cavity;
an elastomeric filled in the cavity and sealed the part of each the body portion, the waterproof plastic having an annular rib protruded beyond an outer surface of the base section of the first insulator; and
a shell enclosed the first insulator and the elastomeric, the annular rib being squeezed by an inner surface of the shell.

12. The waterproof connector as claimed in claim 11, wherein at least an annular concave groove is formed on the elastomeric to contain a deformation part of the annular rib when the annular rib is squeezed.

13. A waterproof connector, comprising:
a front interior plastic body having a plurality of front terminal slots formed on a top surface and a bottom surface of the front interior plastic body;
a rear interior plastic body having a plurality of rear terminal slots formed on a top surface and a bottom surface of the rear interior plastic body;
a central isolation plate positioned in the front inter plastic body and the rear plastic body by a first injection molding;
a plurality of upper terminals having body portions, front ends of the body portions of the upper terminals positioned in the front terminal slots of the top surface of the front interior plastic body, rear ends of the body portions of the upper terminals positioned in the rear terminal slots of the top surface of the rear interior plastic body;
a plurality of lower terminals having body portions, front ends of the body portions of the lower terminals positioned in the front terminal slots of the bottom surface of the front interior plastic body, rear ends of the body portions of the lower terminals positioned in the rear terminal slots of the bottom surface of the rear interior plastic body;
a front external plastic body enclosed the front interior plastic body by a second injection molding to form a base section and a tongue section extended from a front surface of the body section, the upper terminals and the lower terminals having contacting sections connected to the front ends of the body portions, the contacting sections of the upper terminals exposed from a top surface of the tongue section, the contacting sections of the lower terminals exposed from a bottom surface of the tongue section;
a rear external plastic body enclosed the rear interior plastic body by the second injection molding, the upper terminals and the lower terminals having solder feet connected to the rear ends of the body portions, the solder feet exposed from a bottom surface of the rear external plastic body, the solder feet of the upper terminals arranged in a front row, the solder feet of the lower terminals arranged in a rear row which is behind the front row;
a cavity formed between the front external plastic body and the rear external plastic body, the body portions of the upper terminals and the lower terminals having middle sections which are connected between the front ends and the rear ends of the body portions, the middle sections of the body portions of the upper terminals and the lower terminals exposed from the cavity;
an elastomeric fully filled the cavity and sealed the middle sections of the body portions of the upper terminals and the lower terminals by a third injection molding, the waterproof plastic having an annular rib protruded beyond an outer surface of the base section of the front external plastic body; and
a shell enclosed the front external plastic body and the elastomeric to squeeze the annular rib and deform the annular rib.
